(19) United States
(12) Patent Application Publication
(10) Pub. No.: US 2025/0048420 A1
(43) Pub. Date: Feb. 6, 2025

(54) CALCULATING A RANDOM ACCESS-RADIO NETWORK TEMPORARY IDENTIFIER (RA-RNTI) FOR MULTIPLE PHYSICAL RANDOM ACCESS CHANNEL (PRACH) TRANSMISSIONS

(71) Applicant: QUALCOMM Incorporated, San Diego, CA (US)

(72) Inventors: Hung Dinh LY, San Diego, CA (US); Kexin XIAO, Shanghai (CN); Hwan Joon KWON, San Diego, CA (US)

(21) Appl. No.: 18/713,513

(22) PCT Filed: Feb. 24, 2022
(86) PCT No.: PCT/CN2022/077582

§ 371 Date: May 24, 2024

(51) Int. Cl. H04W 74/00; H04W 74/0833

(52) U.S. Cl. CPC H04W 74/006; H04W 74/0833

(57) ABSTRACT

A method for wireless communication performed by a user equipment (UE) includes transmitting, to a network node, a group of physical random access channel (PRACH) preambles. Each PRACH preamble may be transmitted during a respective PRACH occasion of a group of PRACH occasions. The method also includes receiving, from the network node via a downlink control channel, a downlink grant indicating downlink resources for receiving a random access response (RAR) based on transmitting the group of PRACH preambles. The downlink control channel may be scrambled based on a random access-radio network temporary identifier (RA-RNTI) associated with a single PRACH occasion of the group of PRACH occasions. The method still further includes receiving, from the network node via the downlink resources, the RAR based on receiving the downlink grant. The method also includes transmitting, to the network node, a random access message based on receiving the RAR.

### FIELD OF THE DISCLOSURE

The present disclosure relates generally to wireless communications, and more specifically to determining a random access-radio network temporary identifier (RA-RNTI) for multiple physical random access channel (PRACH) transmissions

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

In wireless communication systems, including 5G new radio (NR) systems, a user equipment (UE) may perform a random access procedure for various reasons, including, for example, initial access to a network, transitioning from an inactive or idle radio resource control (RRC) state to a connected RRC state, performing handover from a source cell to a target cell, beam failure recovery, uplink timing recovery, or small uplink data transmissions. In some examples, the UE may initiate the random access procedure by transmitting a physical random access channel (PRACH) preamble on a PRACH. The PRACH preamble may be transmitted during a PRACH occasion. In such examples, the UE may receive a downlink grant on a downlink control channel based on transmitting the PRACH preamble. The downlink grant may indicate downlink resources for receiving a random access response (RAR) based on transmitting the PRACH preamble. The downlink control channel may be scrambled based on a random access-radio network temporary identifier (RA-RNTI) associated with the PRACH occasion.

### SUMMARY

In one aspect of the present disclosure, a method for method for wireless communication performed by a user equipment (UE) includes transmitting, to a network node, a group of physical random access channel (PRACH) preambles. Each PRACH preamble may be transmitted during a respective PRACH occasion of a group of PRACH occasions. The method further includes receiving, from the network node via a downlink control channel, a downlink grant indicating downlink resources for receiving a random access response (RAR) based on transmitting the group of PRACH preambles. The downlink control channel may be scrambled based on random access-radio network temporary identifier (RA-RNTI) associated with a single PRACH occasion of the group of PRACH occasions. The method still further includes receiving, from the network node via the downlink resources, the RAR based on receiving the downlink grant. The method also includes transmitting, to the network node, a random access message based on receiving the RAR.

Another aspect of the present disclosure is directed to an apparatus including means for transmitting, to a network node, a group of PRACH preambles. Each PRACH preamble may be transmitted during a respective PRACH occasion of a group of PRACH occasions. The apparatus further includes means for receiving, from the network node via a downlink control channel, a downlink grant indicating downlink resources for receiving an RAR based on transmitting the group of PRACH preambles. The downlink control channel may be scrambled based on an RA-RNTI associated with a single PRACH occasion of the group of PRACH occasions. The apparatus still further includes means for receiving, from the network node via the downlink resources, the RAR based on receiving the downlink grant. The apparatus also includes means for transmitting, to the network node, a random access message based on receiving the RAR.

In another aspect of the present disclosure, a non-transitory computer-readable medium with non-transitory program code recorded thereon is disclosed. The program code is executed by a processor and includes program code to transmit, to a network node, a group of PRACH preambles. Each PRACH preamble may be transmitted during a respective PRACH occasion of a group of PRACH occasions. The program code further includes program code to receive, from the network node via a downlink control channel, a downlink grant indicating downlink resources for receiving an RAR based on transmitting the group of PRACH preambles. The downlink control channel may be scrambled based on an RA-RNTI associated with a single PRACH occasion of the group of PRACH occasions. The program code still further includes program code to receive, from the network node via the downlink resources, the RAR based on receiving the downlink grant. The program code also includes program code to transmit, to the network node, a random access message based on receiving the RAR.

Another aspect of the present disclosure is directed to an apparatus for wireless communications at a UE. The apparatus includes a processor, and a memory coupled with the processor and storing instructions operable, when executed by the processor, to cause the apparatus to transmit, to a network node, a group of PRACH preambles. Each PRACH preamble may be transmitted during a respective PRACH occasion of a group of PRACH occasions. Execution of the instructions further cause the apparatus to receive, from the network node via a downlink control channel, a downlink grant indicating downlink resources for receiving an RAR based on transmitting the group of PRACH preambles. The downlink control channel may be scrambled based on an RA-RNTI associated with a single PRACH occasion of the group of PRACH occasions. Execution of the instructions also cause the apparatus to receive, from the network node via the downlink resources, the RAR based on receiving the downlink grant. Execution of the instructions still further cause the apparatus to transmit, to the network node, a random access message based on receiving the RAR.

In one aspect of the present disclosure, a method for method for wireless communication performed by a network node includes receiving a group of PRACH preambles. Each PRACH preamble may be associated with a respective PRACH occasion of a group of PRACH occasions configured at a UE. The method further includes transmitting, via a downlink control channel, a downlink grant indicating downlink resources for receiving an RAR based on receiving the group of PRACH preambles, the downlink control channel may be scrambled based on an RA-RNTI associated with a single PRACH occasion of the group of PRACH occasions. The method still further includes transmitting, via the downlink resources, the RAR based on transmitting the downlink grant. The method also includes receiving a random access message based on transmitting the RAR.

Another aspect of the present disclosure is directed to an apparatus including means for receiving a group of PRACH preambles. Each PRACH preamble may be associated with a respective PRACH occasion of a group of PRACH occasions configured at a UE. The apparatus further includes means for transmitting, via a downlink control channel, a downlink grant indicating downlink resources for receiving an RAR based on receiving the group of PRACH preambles, the downlink control channel may be scrambled based on an RA-RNTI associated with a single PRACH occasion of the group of PRACH occasions. The apparatus still further includes means for transmitting, via the downlink resources, the RAR based on transmitting the downlink grant. The apparatus also includes means for receiving a random access message based on transmitting the RAR.

In another aspect of the present disclosure, a non-transitory computer-readable medium with non-transitory program code recorded thereon is disclosed. The program code is executed by a processor and includes program code to receive a group of PRACH preambles. Each PRACH preamble may be associated with a respective PRACH occasion of a group of PRACH occasions configured at a UE. The program code further includes program code to transmit, via a downlink control channel, a downlink grant indicating downlink resources for receiving an RAR based on receiving the group of PRACH preambles, the downlink control channel may be scrambled based on an RA-RNTI associated with a single PRACH occasion of the group of PRACH occasions. The program code still further includes program code to transmit, via the downlink resources, the RAR based on transmitting the downlink grant. The program code also includes program code to receive a random access message based on transmitting the RAR.

Another aspect of the present disclosure is directed to an apparatus for wireless communications at a network node. The apparatus includes a processor, and a memory coupled with the processor and storing instructions operable, when executed by the processor, to cause the apparatus to receive a group of PRACH preambles. Each PRACH preamble may be associated with a respective PRACH occasion of a group of PRACH occasions configured at a UE. Execution of the instructions also cause the apparatus to transmit, via a downlink control channel, a downlink grant indicating downlink resources for receiving an RAR based on receiving the group of PRACH preambles, the downlink control channel may be scrambled based on an RA-RNTI associated with a single PRACH occasion of the group of PRACH occasions. Execution of the instructions further cause the apparatus to transmit, via the downlink resources, the RAR based on transmitting the downlink grant. Execution of the instructions still further cause the apparatus to receive a random access message based on transmitting the RAR.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 shows a diagram illustrating an example disaggregated base station architecture.

FIG. 4 is a timing diagram illustrating an example of a four-step random access procedure, in accordance with aspects of the present disclosure.

FIG. 5 is a block diagram illustrating an example of a group of physical random access channel (PRACH) occasions, in accordance with aspects of the present disclosure.

FIGS. 6A, 6B, 6C, and 6D are block diagrams illustrating examples of a group of PRACH occasions, in accordance with aspects of the present disclosure.

FIG. 7 is a block diagram illustrating an example wireless communication device that supports multiple PRACH transmissions, in accordance with some aspects of the present disclosure.

FIG. 8 is a flow diagram illustrating an example of a process performed by aUE, in accordance with some aspects of the present disclosure.

FIG. 9 is a block diagram illustrating an example wireless communication device that supports receiving multiple PRACH transmissions from a single UE, in accordance with some aspects of the present disclosure.

FIG. 10 is a flow diagram illustrating an example of a process performed by a network device, in accordance with some aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

In wireless communication systems, including 5G new radio (NR) systems, a user equipment (UE) may perform a random access procedure for various reasons, including, for example, initial access to a network, transitioning from an inactive or idle radio resource control (RRC) state to a connected RRC state, performing handover from a source cell to a target cell, beam failure recovery, uplink timing recovery, or small uplink data transmissions. In some examples, the UE may initiate the random access procedure by transmitting a physical random access channel (PRACH) preamble on a PRACH. The PRACH preamble may be transmitted during a PRACH occasion. In such examples, the UE may receive a downlink grant on a downlink control channel based on transmitting the PRACH preamble. The downlink grant may indicate downlink resources for receiving a random access response (RAR) based on transmitting the PRACH preamble. The downlink control channel may be scrambled based on a random access-radio network temporary identifier (RA-RNTI) associated with the PRACH occasion. Specifically, a network node may generate the RA-RNTI based on one or more indices associated with the PRACH occasion.

In a conventional wireless communication system, the UE may be limited to transmitting a single PRACH preamble. However, in some examples, the UE may repeat the PRACH preamble transmission based on a value of a downlink reference signal received power (RSRP) being less than or equal to an RSRP threshold. In such examples, each PRACH preamble of a group of PRACH preamble transmissions may be transmitted during a respective PRACH occasion of a group of PRACH occasions. The group of PRACH occasions may be associated with a same spatial domain filter. In such examples, the network node may transmit a single RAR based on receiving the multiple PRACH preambles. Because the network node only transmits the single RAR, only one PRACH occasion of the group of PRACH occasions may be used to calculate an RA-RNTI associated with the single RAR.

Aspects of the present disclosure generally relate to wireless communication, and specifically to techniques and apparatuses for selecting a PRACH occasion from a group of PRACH occasions for calculating an RA-RNTI associated with a single RAR. In such examples, a UE may transmit, to a network node, a group of PRACH preambles. Each PRACH preamble may be associated with a respective PRACH occasion of a group of PRACH occasions. The UE may then receive, from the network node via a downlink control channel, a downlink grant indicating downlink resources for receiving an RAR based on transmitting the group of PRACH preambles. The downlink control channel may be scrambled based on an RA-RNTI associated with a single PRACH occasion of the group of PRACH occasions. In some examples, the single PRACH occasion may be associated with an initial PRACH preamble transmission of the group of PRACH preamble transmissions. In other examples, the single PRACH occasion may be associated with a final PRACH preamble transmission of the group of PRACH preamble transmissions. In some other examples, the UE may receive, from the network node, a message indicating an index associated with the single PRACH occasion, where each PRACH occasion of the group of PRACH occasions is associated with a different index. In still some other examples, the single PRACH occasion may be used to configure an RAR window at the UE. After receiving the downlink grant, the UE may receive, from the network node via the downlink resources, the RAR. The UE may then transmit a random access message to the network node based on receiving the RAR.

Particular aspects of the subject matter described in this disclosure may be implemented to realize one or more of the following potential advantages. In some examples, the described techniques may overcome the limitations of conventional wireless systems that calculate an RA-RNTI based on a PRACH occasion associated with a single PRACH transmission. In such examples, the described techniques specify a process for calculating the RA-RNTI based on a PRACH occasion associated with one PRACH transmission of a group of PRACH transmissions from a single UE. By specifying the process for calculating the RA-RNTI, a wireless communication system may support multiple PRACH transmissions from the single UE. In some examples, communication reliability may be improved when the wireless communication system supports multiple PRACH transmissions from the single UE, such as when the single UE is a cell-edge UE.

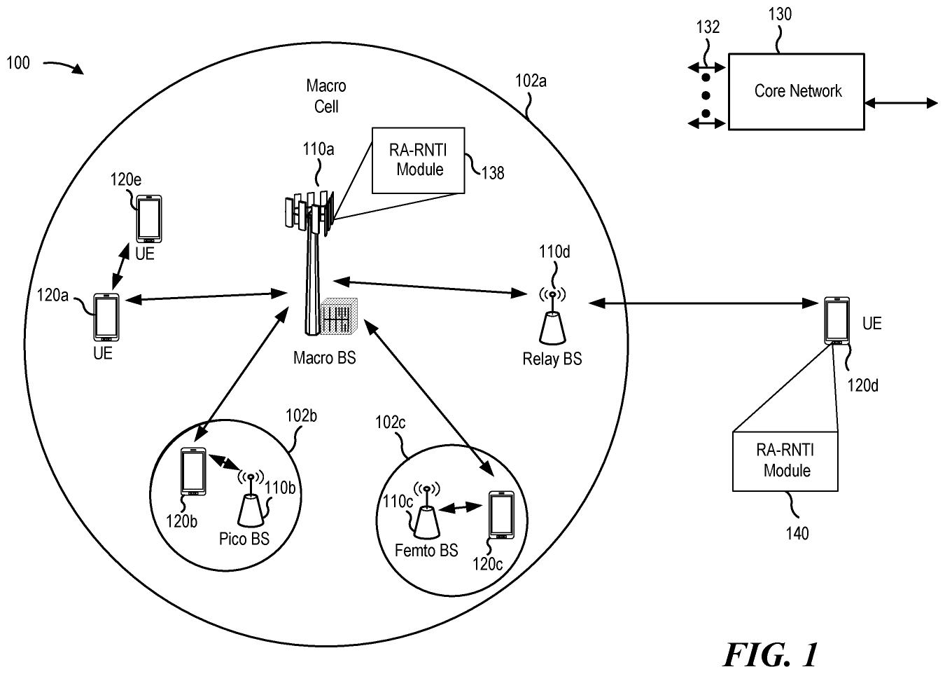

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

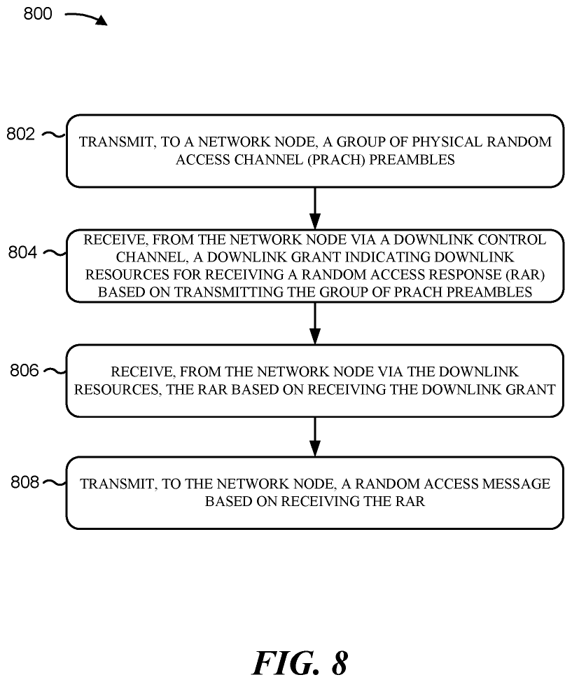

The UEs 120 may include an RA-RNTI module 140. For brevity, only one UE 120d is shown as including the RA-RNTI module 140. The RA-RNTI module 140 may be configured to perform the operations of the process 800 described with reference to FIG. 8.

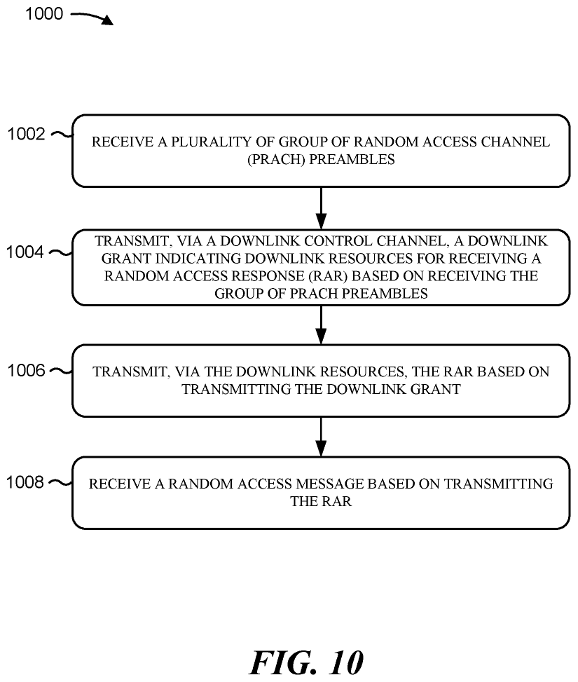

The core network 130 or the base stations 110 may include an RA-RNTI module 138. The RA-RNTI module may be configured to perform the operations of the process 1000 described with reference to FIG. 10.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), RRC signaling, a media access control-control element (MAC-CE) or via system information (e.g., a system information block (SIB).

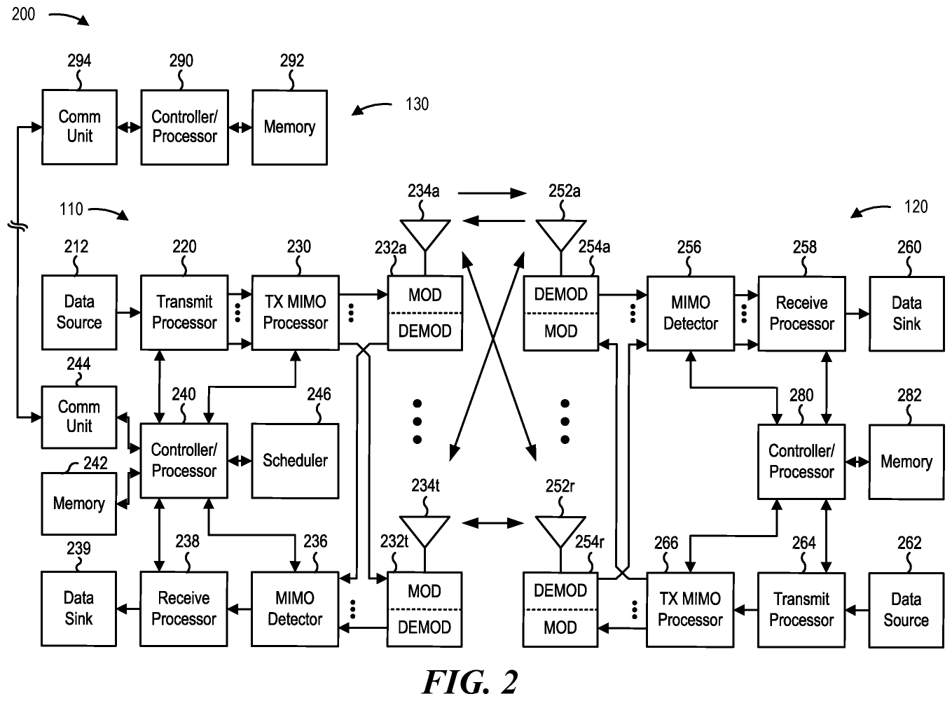

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with determining an RA-RNTI for multiple PRACH transmissions from a single UE as described in more detail elsewhere. For example, the controller/processor 240 of the base station 110, the controller/processor 280 of the UE 120, and/or any other component(s) of FIG. 2 may perform or direct operations of, for example, the processes of FIGS. 8 and 10 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, e.g., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

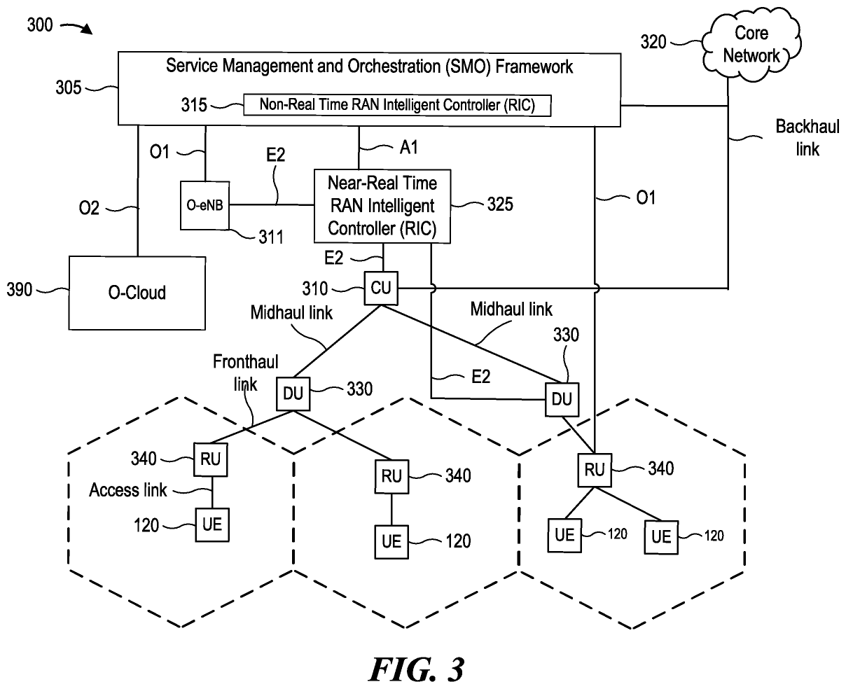

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) X11, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

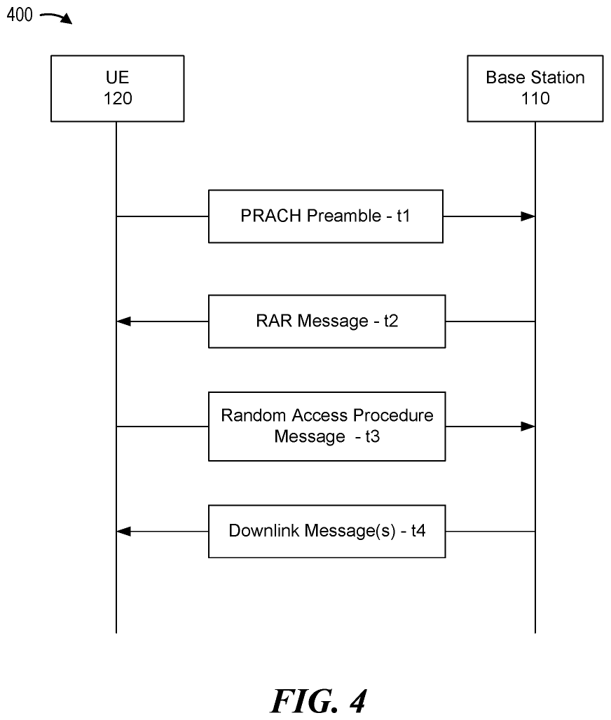

FIG. 4 is a timing diagram illustrating an example 400 of a four-step random access procedure, in accordance with aspects of the present disclosure. In some examples, as shown in FIG. 4, at time t1, the UE 120 may transmit a PRACH preamble on a PRACH to the base station 110. In some examples, the base station 110 of FIG. 4 may be a DU 330 or a CU 310 as described with reference to FIG. 3. That PRACH preamble may be transmitted during a PRACH occasion. The PRACH preamble may initiate a random access procedure with the base station 110. In such examples, the PRACH preamble may be an example of the first message (for example, Msg1) of the four-step random access procedure. In such examples, the PRACH preamble may include timing information for uplink transmissions that allow the base station 110 to set timing advance parameters, for example.

As shown in FIG. 4, at time t2, the UE 120 receives an RAR message from the base station 110. The RAR message may be an example of the second message (for example, Msg2) of the four-step random access procedure. The RAR message may include timing advance parameters, an uplink grant for a random access procedure message transmission (for example, a Msg3 transmission), or a temporary cell radio network temporary identifier (TC-RNTI). In some instances, the base station 110 may transmit the TC-RNTI to indicate the scrambling sequence used for a fourth message (for example, Msg4) of the four-step random access procedure transmission. The scrambling sequence enables the base station 110 to simultaneously communicate with multiple UEs. Each UE may be associated with a unique scrambling sequence for the fourth message. The base station 110 may separate the signals from the different UEs based on the respective scrambling sequences.

In some examples, the RAR message may be transmitted on a physical downlink shared channel (PDSCH). Although not shown in FIG. 4, in some examples, prior to time t2, the UE 120 may decode a physical downlink control channel (PDCCH) to obtain the DCI that indicates scheduling information for the PDSCH carrying the RAR message. The UE 120 may receive the PDSCH, at time t2, based on the scheduling information included in the DCI. The PDCCH may be scrambled with an RA-RNTI that is calculated based on one or more indices associated with the PRACH occasion. Specifically, the base station 110 scrambles the PDCCH's cyclic redundancy check (CRC) with the RA-RNTI. The RA-RNTI may be determined based on the time/frequency resources used for the transmission of the PRACH preamble. In such examples, all UEs transmitting a PRACH preamble on the same resource may have the same RA-RNTI and may be addressed by the same PDCCH. In some cases, the base station 110 may scramble CRC bits for the PDCCH with the RA-RNTI, to enable the UE 120 to determine whether the PDCCH includes control information for the UE 120.

In some implementations, the RA-RNTI associated with the PRACH occasion corresponding to the PRACH preamble may be computed as: RA-RNTI=(1+s_id)+ (14×t_id)+ (14×80×f id)+ (14×80×8×ul carrier id), where s_id represents an index of a first OFDM symbol of the PRACH occasion (0≤s_id<14), t_id represents an index of the first slot of the PRACH occasion in a system frame (0<t_id<80), f_id represents an index of the PRACH occasion in the frequency domain (0<fid<8), and ul_carrier_id represents a UL carrier used for the Msgl transmission (0 for a normal uplink (NUL) carrier, and 1 for a supplementary uplink (SUL) carrier).

In some examples, after receiving the RAR message, the UE 120 transmits a random access procedure message on an uplink shared channel, such as a physical uplink shared channel (PUSCH), at time t3. The random access procedure message may be an example of the third message (for example, Msg3) of the four-step random access procedure. Specifically, the random access procedure messages may be an example of a physical uplink channel transmission, such as a PUSCH Msg3 transmission. The random access procedure message may be transmitted using resources scheduled by the uplink grant included in the RAR message. In some examples, the random access procedure message may include an RRC connection request, a scheduling request, or a buffer status. At time t4, the base station 110 may transmit one or more downlink messages, via one or both of a PDCCH or PDSCH, based on receiving the random access procedure message at time t3.

The RACH procedure depicted in FIG. 4 may be performed in various use cases, including for initial access to a network or cell, when a UE 120 transitions from an RRC Idle/Inactive state to an RRC Connected state (for example, after receiving a paging message), when beam recovery or uplink timing recovery is desired, or when a UE 120 is changing serving base stations 110 during a handover procedure. Further, in some instances, a UE 120 may use the RACH procedure described above to transmit small uplink data transmissions during RRC Idle/Inactive states in order to save on the overhead costs of leaving RRC Idle/Inactive states into RRC Connected state to transmit a relatively small amount of data.

In some examples, prior to a connection procedure between the base station 110 and the UE 120, such as the four-step random access procedure described with reference to FIG. 4, the base station 110 may transmit one or more of a synchronization signal block (SSB), a system information block (SIB), or a reference signal (for example, a demodulation reference signal (DMRS)), to indicate configuration information associated with the four-step random access procedure. Some examples of a random access procedure, such as a four-step random access procedure may be contention-based or contention-free. To transmit random access messages and initiate a random access procedure, the UE 120 may first identify information, such as synchronization information, for the base station 110 and system information for the design 200. The base station 110 may transmit (for example, periodically) synchronization information and system information in one or both of the SSB or the SIB. In some examples, the synchronization information and system information may be transmitted in the SSB and a physical broadcast channel (PBCH) block (for example, an SS/PBCH block). The base station 110 may transmit a reference signal, such as a DMRS, on the PBCH to assist the UE 120 in decoding the SSB and synchronizing with the base station 110.

The SSB may include synchronization information for synchronize downlink communications from the base station 110. In some examples, the SSB may include a primary synchronization signal (PSS), a secondary synchronization signal (SSS), and a PBCH block. The PBCH block may include a master information block (MIB), which may indicate a location of one or more SIBs. In some examples, the SIB of the PBCH (for example, a SIB1) block may indicate communication resources, such as a RACH or PRACH configuration, for the random access procedure.

In some examples, prior to performing a contention-based random access procedure, the base station 110 may configure the UE 120 with an SSB to PRACH occasion association. The PRACH occasion may indicate time and frequency resources for transmitting, on a respective directional beam, a random access message in a random access procedure, such as msg1 of a four-step random access message using a configured PRACH preamble format. The SSB to PRACH occasion association may be between a respective directional beam carrying an SSB and a respective directional beam carrying msg1 of the four-step random access procedure on the PRACH occasion.

The UE 120 may receive, from the base station 110, a number (N) of SSBs associated within a single PRACH occasion and a number (R) of contention-based preambles per SSB per valid PRACH occasion, where N and R are positive values. For example, the UE 120 may be provided N SS/PBCH blocks associated with one PRACH occasion and R contention-based preambles per SS/PBCH block by a higher layer parameter. In some examples, when N is less than a threshold, for example, N<1, then one SS/PBCH block may be mapped to a fraction of consecutive SSBs for consecutive valid PRACH occasions (for example, 1/N consecutive valid PRACH occasions). Alternatively, when N is greater than or equal to a threshold, for example, N≥1, then N SS/PBCH blocks may be mapped to one valid PRACH occasion. If N≥1, R contention-based preambles with consecutive indexes associated with SS/PBCH block N, mapping per PRACH occasion may begin from an initial preamble index. In some examples, SS/PBCH block indices may be mapped to PRACH occasion based on an order, for example, an increasing order of preamble indices within a single PRACH occasion, increasing order of frequency resource indexes for frequency multiplexed PRACH occasions, or increasing order of time resource indexes for time-multiplexed PRACH occasions. The base station 110 and the UE 120 may map SSBs to one or more PRACH occasions during one or more PRACH configuration periods of an association pattern period. The association pattern period may be defined based on the one or more PRACH configuration periods.

An association pattern period, starting from an initial frame (for example, frame 0), for mapping SS/PBCH blocks to PRACH occasions may be a value in a set determined by a PRACH configuration period according to Table 1, such that SS/PBCH blocks are mapped at least once to the PRACH occasions within an association pattern period. Table 1 may therefore illustrate a mapping between a PRACH configuration period and SS/PBCH blocks to PRACH occasion association pattern periods (for example, a number of PRACH configuration periods)

TABLE 1
Mapping between PRACH configuration periods and SS/PBCH
block to PRACH occasions association pattern period

| PRACH configuration | Association pattern period (number |
|---|---|
| period (msec) | of PRACH configuration periods) |
| 10 | {1, 2, 4, 8, 16} |
| 20 | {1, 2, 4, 8} |
| 40 | {1, 2, 4\| |
| 80 | {1, 2} |
| 160 | {1} |

In some examples, an association pattern period may include one or more association periods, such that a pattern between PRACH occasions and SS/PBCH blocks repeats, for example, at most every 160 msec. PRACH occasions not associated with SS/PBCH blocks after an integer number of association pattern periods, if any, may not be used for PRACH transmissions.

Various coverage enhancements have been proposed for improving PRACH coverage for cell-edge devices, such as cell edge UEs. These coverage enhancements include, but are not limited to, performing multiple PRACH transmissions with a same beam or different beams for a four-step RACH procedure. The coverage enhancements may apply to FR2 or FR1. Additionally, the coverage enhancements may be associated with short PRACH formats or other formats.

In some examples, the coverage enhancements may depend on a downlink reference signal received power (RSRP) condition. In such examples, a UE may repeat a PRACH transmission based on the downlink RSRP satisfying a repetition condition. In some examples, the downlink RSRP may satisfy the repetition condition based on the RSRP being less than an RSRP threshold. In one such example, a downlink RSRP measured by a cell-edge UE may satisfy the repetition condition and a downlink RSRP measured by a cell-center UE may not satisfy the repetition condition. A cell-center UE is an example of a UE near a base station, while a cell-edge UE is an example of a UE near a border of a cell. In the current example, the cell-edge UE may repeat a PRACH transmission. For example, the cell-edge UE may transmit multiple PRACH preambles (for example, PRACH repetitions), where each PRACH preamble transmission is associated with a different PRACH occasion of a group of PRACH occasions using a same spatial domain filter.

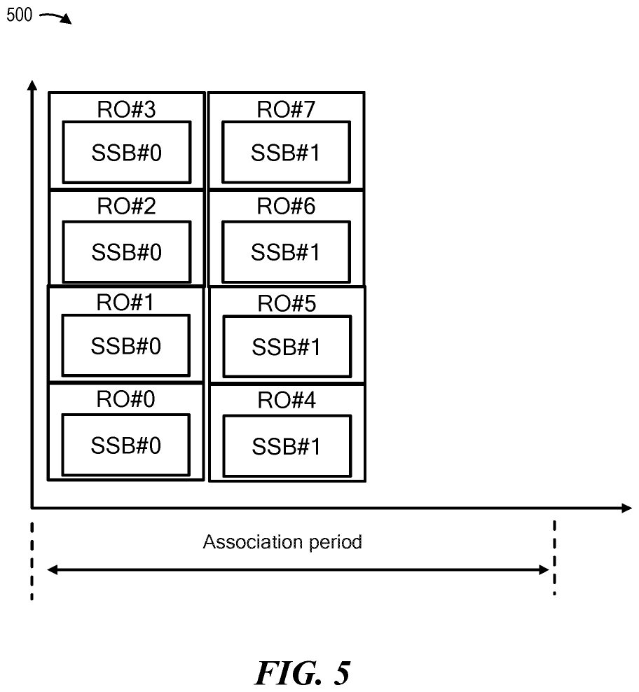

FIG. 5 is a block diagram illustrating an example 500 of a group of PRACH occasions, in accordance with aspects of the present disclosure. In the example 500 of FIG. 5, a base station, such as a base station 110 described with reference to FIGS. 1, 2, and 4, a DU 330 described with reference to FIG. 3, or a CU 310 described with reference to FIG. 3, may configure multiple groups of PRACH occasions within an associated period. Based on the configuration, a UE, such as a UE 120 described with reference to FIGS. 1, 2, 3, and 4, may perform one or more PRACH transmissions (for example, PRACH preamble transmissions) via the configured PRACH occasions. As discussed, each PRACH occasion is associated with time and frequency resources for a PRACH transmission. Additionally, as shown in FIG. 5, each PRACH occasion in a group of PRACH occasions may be associated with a same SSB (for example, spatial domain filter). Specifically, a first group of PRACH occasions (ROs), including PRACH occasions RO #0 to RO #3, may be associated with a first SSB, shown as SSB #0, and a second group of PRACH occasions, including PRACH occasions RO #4 to RO #7, may be associated with a second SSB, shown as SSB #1. Alternatively, in some examples, each PRACH occasion in a group of PRACH occasions may be associated with a same channel state information reference signal (CSI-RS) rather than being associated with a same SSB. Aspects of the present disclosure are not limited to the PRACH occasions groups shown in FIG. 5. Each PRACH occasion group may have more or fewer PRACH occasions. Additionally, fewer or more PRACH occasion groups may be associated with an associated period.

Although a UE (for example, cell-edge UE) may repeat a PRACH preamble transmission, conventional wireless standards define an RA-RNTI for a single PRACH occasion. Therefore, for multiple PRACH preamble transmissions, a base station may be limited to transmitting an RAR in response to one PRACH preamble transmission of the group of PRACH preamble transmissions, rather than transmitting an RAR in response to each PRACH preamble transmission of the group of PRACH preamble transmissions. Various aspects of the present disclosure are directed to identifying a PRACH occasion to use for calculating an RA-RNTI based on a UE transmitting multiple PRACH preambles, where each PRACH preamble transmission is associated with a respective PRACH occasion of a PRACH occasion group.

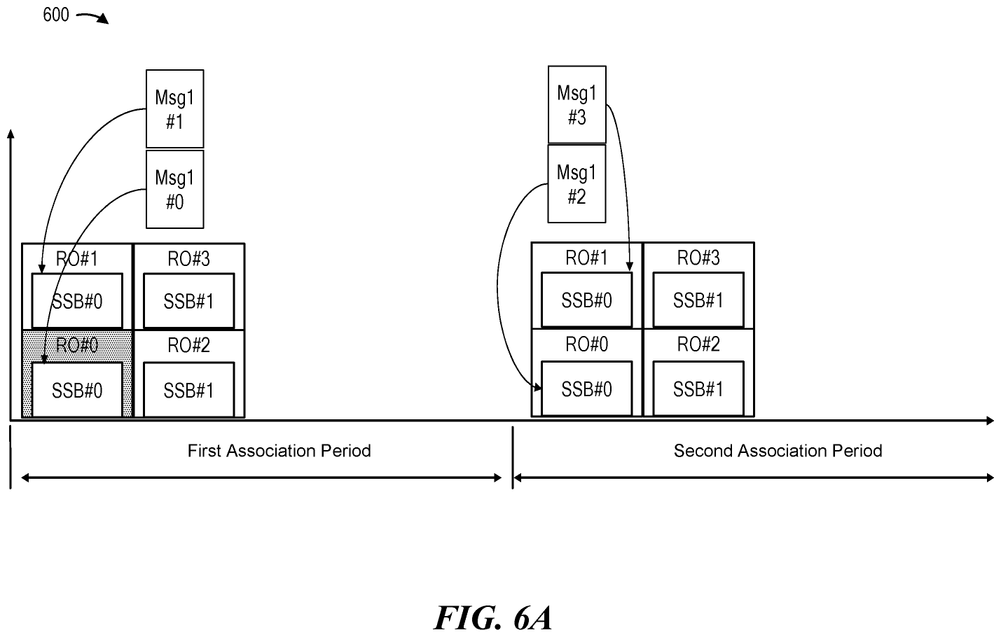

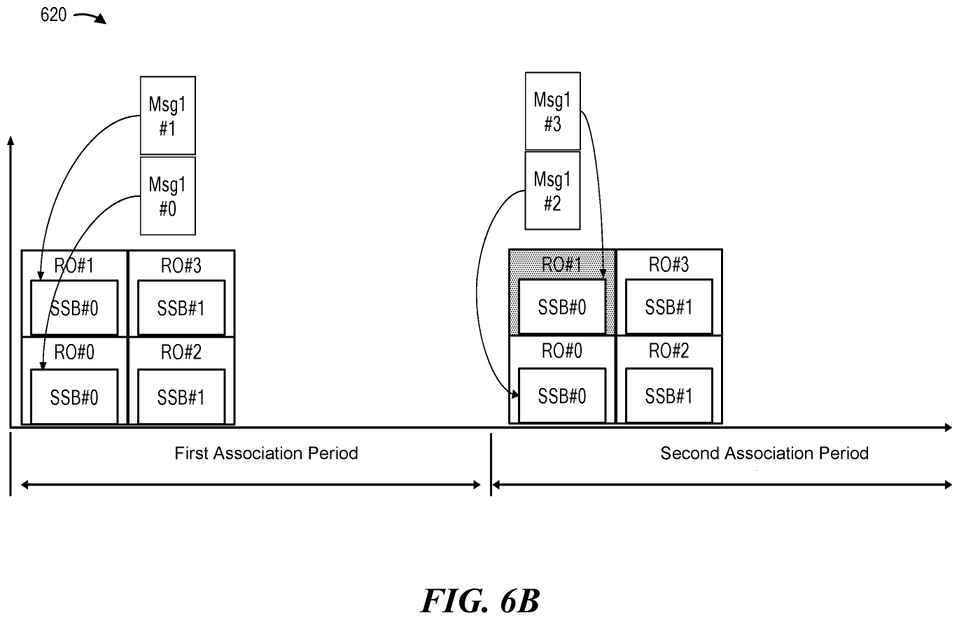

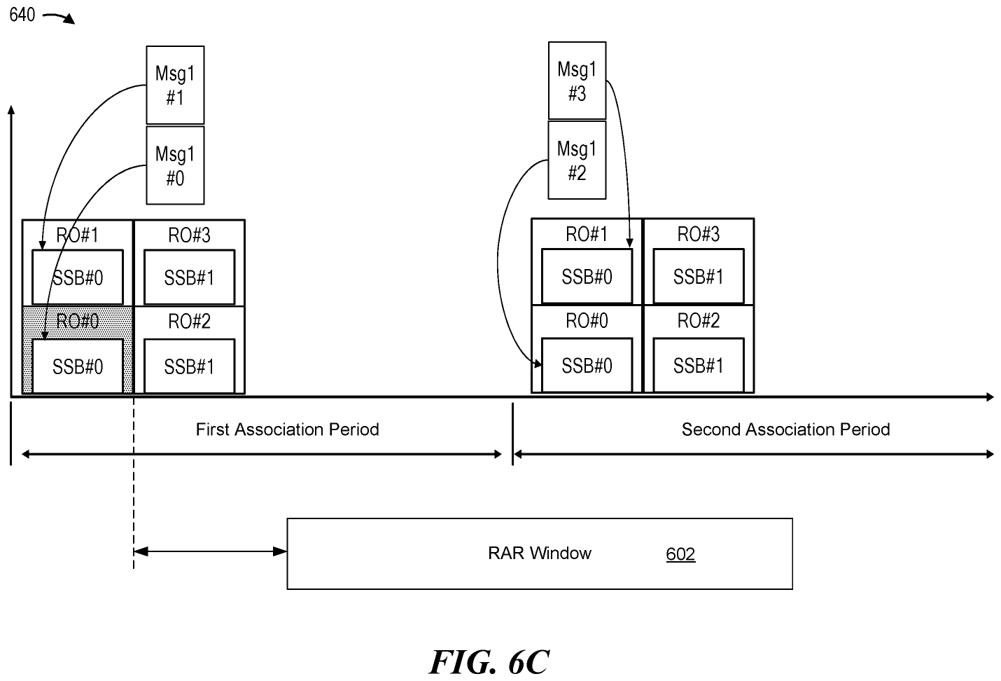

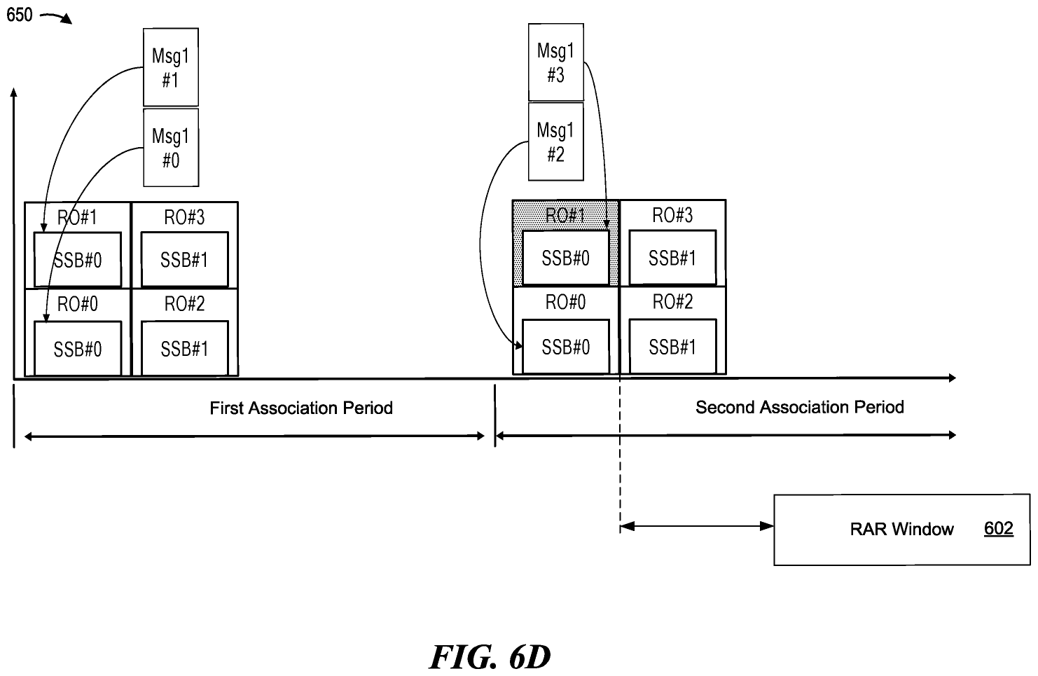

In some implementations, an RA-RNTI may use a PRACH occasion associated with an initial PRACH preamble transmission from a group of PRACH preamble transmissions. An example of the PRACH occasion associated with the initial PRACH preamble transmission is shown in FIG. 6A, which is a block diagram illustrating an example 600 of a group of PRACH occasions, in accordance with aspects of the present disclosure. In the example 600 of FIG. 6A, a base station, such as a base station 110 described with reference to FIGS. 1, 2, 3, and 4, a DU 330 described with reference to FIG. 3, or a CU 310 described with reference to FIG. 3, may configure one or more PRACH occasion groups within an associated period. Based on the configuration, a UE, such as a UE 120 described with reference to FIGS. 1, 2, 3, and 4, may perform one or more PRACH transmissions (for example, PRACH preamble transmissions) via the PRACH occasions associated with one or more of the PRACH occasion groups. As previously discussed, the association period may be repeated within an associated pattern period. The example 600 of FIG. 6A illustrates an example of two association periods within the association pattern period. Additionally, in the example 600, two different PRACH groups may be configured for the association periods.

As shown in the example 600 of FIG. 6A, each PRACH occasion in a group of PRACH occasions may be associated with a same SSB. Specifically, in the example 600 of FIG. 6A, a first PRACH occasion group includes a first PRACH occasion and a second PRACH occasion, shown as RO #0 and RO #1, respectively. The first PRACH occasion group may be associated with a first SSB, shown as SSB #0. Additionally, a second PRACH occasion group may include a third PRACH occasion and a fourth PRACH occasion, shown as RO #2 and RO #3, respectively. The second PRACH occasion group may be associated with a second SSB, shown as SSB #1. In the example 600 of FIG. 6A, the UE may be configured to perform a RACH procedure, such as the four-step RACH procedure described with reference to FIG. 4, via the PRACH occasions associated with the first PRACH occasions group. Additionally, the UE may repeat the PRACH preamble transmission at each PRACH occasion associated with the first PRACH occasion group. For example, as shown in FIG. 6A, during a first association period, the UE may transmit a first PRACH preamble (for example, Msg1), shown as Msg1 #0, via the first PRACH occasion RO #0 and a second PRACH preamble, shown as Msg1 #1, via the second PRACH occasion RO #1. Additionally, during a second association period, the UE may transmit a third PRACH preamble, shown as Msg1 #2, via the first PRACH occasion RO #O and a second PRACH preamble, shown as Msg1 #3, via the second PRACH occasion RO #1. In some examples, one PRACH associated period may not support all repetitions of the PRACH preamble transmission. Therefore, in such examples, the repetition of the PRACH preamble transmission may be performed across two or more association periods. For example, as shown in FIG. 6A, the first PRACH preamble and the second PRACH preamble may be transmitted at each associated period.

As discussed, a base station may be limited to transmitting a single RAR in response to receiving a PRACH preamble transmission from each PRACH occasion in a PRACH occasion group. Therefore, the base station may use a single PRACH occasion from the first PRACH occasion group to calculate the RA-RNTI associated with the RAR. In some examples, the PRACH occasion associated with the initial PRACH preamble transmission may be used to calculate the RA-RNTI associated with the RAR. In the example 600 of FIG. 6A, the first PRACH occasion RO #0 within the first association period is associated with the initial PRACH preamble transmission Msg1 #0.

In other examples, a PRACH occasion associated with a final PRACH preamble transmission may be used to calculate the RA-RNTI associated with the RAR. An example of a PRACH occasion associated with the final PRACH preamble transmission is shown in FIG. 6B, which is a block diagram illustrating an example 620 of a group of PRACH occasions, in accordance with aspects of the present disclosure. In FIG. 6B, the first PRACH occasion group and the second PRACH occasion group are the same as described with respect to FIG. 6A. For brevity, description of the first PRACH occasion group, the second PRACH occasion group, and the association period of FIG. 6B is omitted. In FIG. 6B, the second PRACH occasion RO #1 in the second association period is associated with the final PRACH preamble transmission Msg1 #3.

In some other examples, a network node, such as a base station, may indicate an index of the PRACH occasion that is used to compute the RA-RNTI. In such examples, each PRACH occasion may be associated with a unique index. The network node may indicate the index via a downlink message, such as an RRC message or a system information message.

In still other examples, the PRACH occasion used to calculate the RA-RNTI is also used to determine a start of an RAR window. An example of a PRACH occasion used to determine a start of an RAR window is shown in FIG. 6C, which is a block diagram illustrating an example 640 of a group of PRACH occasions, in accordance with aspects of the present disclosure. In FIG. 6C, the first PRACH occasion group and the second PRACH occasion group are the same as described with respect to FIG. 6A. For brevity, description of the first PRACH occasion group, the second PRACH occasion group, and the association period of FIG. 6C is omitted. In the example 640 of FIG. 6C, the first PRACH occasion RO #0 associated with the first PRACH occasion group within the first association period is used to determine an RAR window 602. The RAR window 602 may be used, by the UE, to detect a DCI format 1_0 with CRC scrambled by the RA-RNTI associated with a designated PRACH occasion, such as RO #0 in the first association period of FIG. 6C. The UE may detect the DCI format 1_0 based on transmitting a PRACH preamble. The RAR window 602 may begin at a first symbol of an earliest control resource set (CORESET) associated with a downlink control channel, such as a PDCCH. The first symbol may be one or more symbols after a last symbol of the PRACH occasion associated with the PRACH preamble transmission. In some examples, a start of the RAR window 602 may be based on either the first PRACH occasion RO #0 or the second PRACH occasion RO #1 associated with the first PRACH occasion group in the first association period.

In some other examples, a PRACH occasion associated with a final PRACH preamble transmission from multiple PRACH preamble repetitions may be used to determine a start of the RAR window. An example of a PRACH occasion used to determine a start of an RAR window is shown in FIG. 6D, which is a block diagram illustrating an example 650 of a group of PRACH occasions, in accordance with aspects of the present disclosure. In FIG. 6D, the first PRACH occasion group and the second PRACH occasion group are the same as described with respect to FIG. 6A. For brevity, description of the first PRACH occasion group, the second PRACH occasion group, and the association period of FIG. 6D is omitted. In the example 650 of FIG. 6D, the second PRACH occasion RO #1 associated with the first PRACH occasion group within the second association period is used to determine the RAR window 602. In this example, the RA-RNTI may be calculated based on the second PRACH occasion associated with the first PRACH occasion group within the second association period. In some examples, a start of the RAR window 602 may be based on either the first PRACH occasion RO #0 or the second PRACH occasion RO #1 associated with the first PRACH occasion group within the second association period.

In some examples, the PRACH occasion used to calculate the RAR window may be a PRACH occasion associated with an initial PRACH preamble transmission, such as the PRACH occasion discussed with reference to FIG. 6A. In other examples, the PRACH occasion used to calculate the RAR window may be a PRACH occasion associated with a final PRACH preamble transmission, such as the PRACH occasions discussed with reference to FIG. 6B. In some other examples, the PRACH occasion used to calculate the RAR window may be a PRACH occasion associated with an index that is indicated via a downlink message received from a network node.

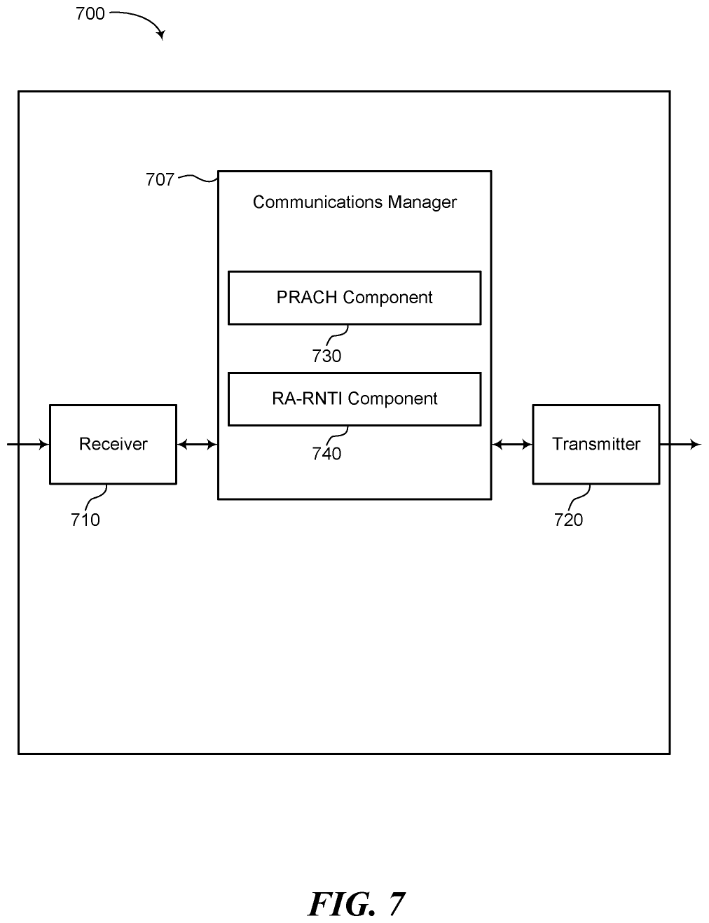

FIG. 7 is a block diagram illustrating an example wireless communication device that supports multiple PRACH transmissions, in accordance with some aspects of the present disclosure. The device 700 may be an example of aspects of a UE 120 described with reference to FIGS. 1, 2, 3, and 4. The wireless communications device 700 may include a receiver 710, a communications manager 707, a transmitter 720, a PRACH component 730, and an RA-RNTI component 740, which may be in communication with one another (for example, via one or more buses). In some examples, the wireless communications device 700 is configured to perform operations, including operations of the processes 800 described below with reference to FIG. 8.

In some examples, the wireless communications device 700 can include a chip, chipset, package, or device that includes at least one processor and at least one modem (for example, a 5G modem or other cellular modem). In some examples, the communications manager 707, or its sub-components, may be separate and distinct components. In some examples, at least some components of the communications manager 707 are implemented at least in part as software stored in a memory. For example, portions of one or more of the components of the communications manager 707 can be implemented as non-transitory code executable by the processor to perform the functions or operations of the respective component.

The receiver 710 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communications devices via various channels including control channels (for example, a physical downlink control channel (PDCCH), physical uplink control channel (PUCCH), or physical shared control channel (PSCCH)) and data channels (for example, a physical downlink shared channel (PDSCH), physical sidelink shared channel (PSSCH), a physical uplink shared channel (PUSCH)). The other wireless communications devices may include, but are not limited to, a base station 110 described with reference to FIGS. 1, 2, and 4, a DU 330 described with reference to FIG. 3, or a CU 310 described with reference to FIG. 3.

The received information may be passed on to other components of the device 700. The receiver 710 may be an example of aspects of the receive processor 258 described with reference to FIG. 2. The receiver 710 may include a set of radio frequency (RF) chains that are coupled with or otherwise utilize a set of antennas (for example, the set of antennas may be an example of aspects of the antennas 252 described with reference to FIG. 2).

The transmitter 720 may transmit signals generated by the communications manager 707 or other components of the wireless communications device 700. In some examples, the transmitter 720 may be collocated with the receiver 710 in a transceiver. The transmitter 720 may be an example of aspects of the transmit processor 264 described with reference to FIG. 2. The transmitter 720 may be coupled with or otherwise utilize a set of antennas (for example, the set of antennas may be an example of aspects of the antennas 252 described with reference to FIG. 2), which may be antenna elements shared with the receiver 710. In some examples, the transmitter 720 is configured to transmit control information in a PUCCH, PSCCH, or PDCCH and data in a physical uplink shared channel (PUSCH), PSSCH, or PDSCH.

The communications manager 707 may be an example of aspects of the controller/processor 280 described with reference to FIG. 2. The communications manager 707 may include the PRACH component 730 and the RA-RNTI component 740. In some examples, working in conjunction with the transmitter 720, the PRACH component 730 may transmit, to a network node (for example, base station), a group of PRACH preambles. Each PRACH preamble may be transmitted during a respective PRACH occasion of a group of PRACH occasions. Additionally, working in conjunction with one or both of the PRACH component 730 or the receiver 710, the RA-RNTI component 740 may receive, from the network node via a downlink control channel, a downlink grant indicating downlink resources for receiving an RAR based on transmitting the group of PRACH preambles. The downlink control channel may be scrambled based on an RA-RNTI associated with a single PRACH occasion of the group of PRACH occasions. Furthermore, working in conjunction with one or both of the RA-RNTI component 740 or the receiver 710, the PRACH component 730 may receive, from the network node via the downlink resources, the RAR based on receiving the downlink grant. Finally, working in conjunction with the transmitter 720, the PRACH component 730 may transmit, to the network node, a random access message based on receiving the RAR.

FIG. 8 is a flow diagram illustrating an example process 800 performed by a UE, in accordance with some aspects of the present disclosure. The UE may be an example of a UE 120 described with reference to FIGS. 1, 2, 3, and 4. The example process 800 is an example of repeating a PRACH transmission. As shown in FIG. 8, the process 800 begins at block 802 by transmitting, to a network node, a group of PRACH preambles. Each PRACH preamble may be transmitted during a respective PRACH occasion of a group of PRACH occasions. At block 804, the process 800 receives, from the network node via a downlink control channel, a downlink grant indicating downlink resources for receiving an RAR based on transmitting the group of PRACH preambles. The downlink control channel may be scrambled based on an RA-RNTI associated with a single PRACH occasion of the group of PRACH occasions. At block 806, the process 800 receives, from the network node via the downlink resources, the RAR based on receiving the downlink grant. At block 808, the process 800 transmits, to the network node, a random access message based on receiving the RAR.

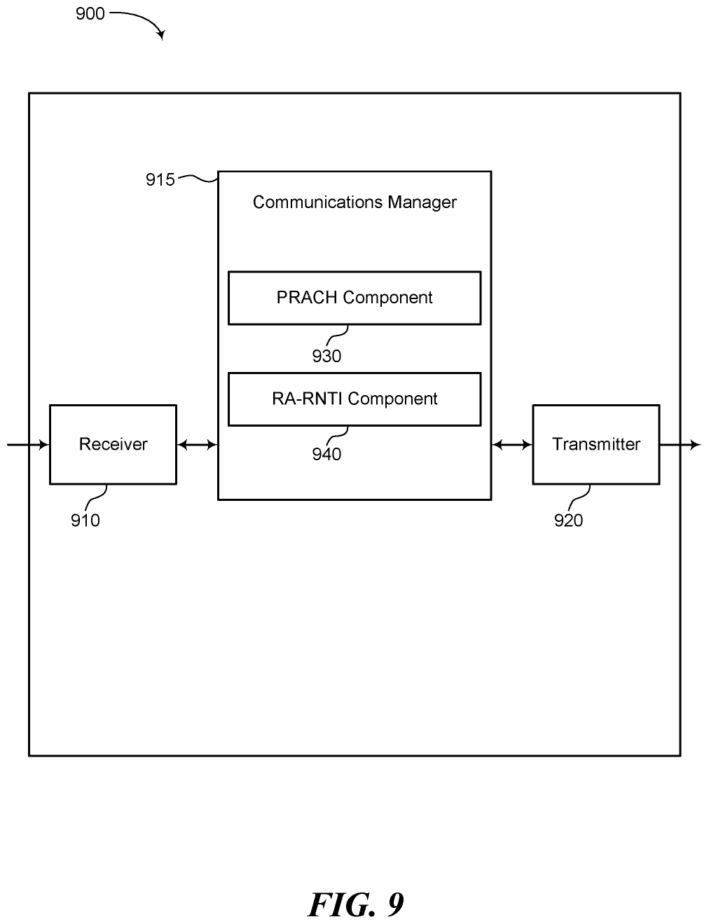

FIG. 9 is a block diagram illustrating an example wireless communication device 900 that supports receiving multiple PRACH transmissions from a single UE, in accordance with aspects of the present disclosure. The wireless communication device 900 may be an example of a base station 110 described with reference to FIGS. 1, 2, and 4, a DU 330 described with reference to FIG. 3, or a CU 310 described with reference to FIG. 3. The wireless communication device 900 may include a receiver 910, a communications manager 915, a PRACH component 930, an RA-RNTI component 940, and a transmitter 920, which may be in communication with one another (for example, via one or more buses). In some examples, the wireless communication device 900 is configured to perform operations, including operations of the process 1000 described below with reference to FIG. 10.

In some examples, the wireless communication device 900 can include a chip, system on chip (SOC), chipset, package, or device that includes at least one processor and at least one modem (for example, a 5G modem or other cellular modem). In some examples, the communications manager 915, or its sub-components, may be separate and distinct components. In some examples, at least some components of the communications manager 915 are implemented at least in part as software stored in a memory. For example, portions of one or more of the components of the communications manager 915 can be implemented as non-transitory code executable by the processor to perform the functions or operations of the respective component.

The receiver 910 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, another base station 110, or a UE 120, described with reference to FIGS. 1-4.

The received information may be passed on to other components of the wireless communication device 900. The receiver 910 may be an example of aspects of the receive processor 238 described with reference to FIG. 2. The receiver 910 may include a set of radio frequency (RF) chains that are coupled with or otherwise utilize a set of antennas (for example, the set of antennas may be an example of aspects of the antennas 234 described with reference to FIG. 2).

The transmitter 920 may transmit signals generated by the communications manager 915 or other components of the wireless communication device 900. In some examples, the transmitter 920 may be collocated with the receiver 910 in a transceiver. The transmitter 920 may be an example of aspects of the transmit processor 220 described with reference to FIG. 2. The transmitter 920 may be coupled with or otherwise utilize a set of antennas (for example, the set of antennas may be an example of aspects of the antennas 234), which may be antenna elements shared with the receiver 910. In some examples, the transmitter 920 is configured to transmit control information in a PDCCH or a PSCCH and data in a PDSCH or PSSCH.

The communications manager 915 may be an example of aspects of the controller/processor 240 described with reference to FIG. 2. The communications manager 915 includes the PRACH component 930 and the RA-RNTI component 940. In some examples, working in conjunction with the receiver 910, the PRACH component 930 may receive a group of PRACH preambles. Each PRACH preamble may be associated with a respective PRACH occasion of a group of PRACH occasions configured at a UE. Working in conjunction with one or both of the PRACH component 930 or the transmitter 920, the RA-RNTI component 940 may transmit, via a downlink control channel, a downlink grant indicating downlink resources for receiving an RAR based on receiving the group of PRACH preambles. The downlink control channel may be scrambled based on an RA-RNTI associated with a single PRACH occasion of the group of PRACH occasions. Additionally, working in conjunction with the transmitter 920, the PRACH component 930 transmits, via the downlink resources, the RAR based on transmitting the downlink grant. Finally, working in conjunction with the receiver 910, the PRACH component 930 receives a random access message based on transmitting the RAR.

FIG. 10 is a flow diagram illustrating an example of a process 1000 performed by network node, in accordance with some aspects of the present disclosure. The wireless device may be an example of a base station 110 described with reference to FIGS. 1, 2, and 4, a DU 330 described with reference to FIG. 3, or a CU 310 described with reference to FIG. 3. The example process 1000 is an example of receiving multiple PRACH transmissions from a single UE. As shown in FIG. 10, the process 1000 begins at block 1002, by receiving a group of PRACH preambles. Each PRACH preamble may be associated with a respective PRACH occasion of a group of PRACH occasions configured at a UE. At block 1004, the process 1000 transmits, via a downlink control channel, a downlink grant indicating downlink resources for receiving an RAR based on receiving the group of PRACH preambles. The downlink control channel may be scrambled based on an RA-RNTI associated with a single PRACH occasion of the group of PRACH occasions. At block 1006, the process 1000 transmits, via the downlink resources, the RAR based on transmitting the downlink grant. At block 1008, the process 1000 receives a random access message based on transmitting the RAR.

Implementation examples are described in the following numbered clauses:
Clause 1. A method for wireless communication performed by a user equipment (UE), comprising: transmitting, to a network node, a plurality of PRACH preambles, each PRACH preamble being transmitted during a respective PRACH occasion of a plurality of PRACH occasions; receiving, from the network node via a downlink control channel, a downlink grant indicating downlink resources for receiving an RAR based on transmitting the plurality of PRACH preambles, the downlink control channel being scrambled based on an RA-RNTI associated with a single PRACH occasion of the plurality of PRACH occasions; receiving, from the network node via the downlink resources, the RAR based on receiving the downlink grant; and transmitting, to the network node, a random access message based on receiving the RAR.
Clause 2. The method of Clause 1, wherein the single PRACH occasion is associated with an initial PRACH preamble transmission of the plurality of PRACH preamble transmissions.
Clause 3. The method of Clause 1, wherein the single PRACH occasion is associated with a final PRACH preamble transmission of the plurality of PRACH preamble transmissions.
Clause 4. The method of Clause 1, wherein each PRACH occasion is associated with a respective index of a plurality of indices, and the method further comprises receiving a message indicating an index associated with the single PRACH occasion.
Clause 5. The method of Clause 1, further comprising configuring an RAR window based on the single PRACH occasion.
Clause 6. The method of any one of Clauses 1-5, wherein the plurality of PRACH preambles are transmitted over two or more PRACH association periods.
Clause 7. The method of any one of Clauses 1-6, wherein the plurality of PRACH occasions are associated with a same SSB or a same CSI-RS.
Clause 8. The method of any one of Clauses 1-7, wherein the random access message indicates a connection request, a scheduling request, or a buffer status request.
Clause 9. A method for wireless communication performed by a network node, comprising: receiving a plurality of PRACH preambles, each PRACH preamble associated with a respective PRACH occasion of a plurality of PRACH occasions configured at a UE; transmitting, via a downlink control channel, a downlink grant indicating downlink resources for receiving an RAR based on receiving the plurality of PRACH preambles, the downlink control channel being scrambled based on an RA-RNTI associated with a single PRACH occasion of the plurality of PRACH occasions; transmitting, via the downlink resources, the RAR based on transmitting the downlink grant; and receiving a random access message based on transmitting the RAR.
Clause 10. The method of Clause 9, wherein the single PRACH occasion is associated with an initial PRACH preamble of the plurality of PRACH preambles.
Clause 11. The method of Clause 9, wherein the single PRACH occasion is associated with a final PRACH preamble of the plurality of PRACH preambles.
Clause 12. The method of Clause 9, wherein each PRACH occasion is associated with a respective index of a plurality of indices, and the method further comprises transmitting a message indicating an index associated with the single PRACH occasion.
Clause 13. The method of any one of Clauses 9-12, wherein the plurality of PRACH preambles are received over two or more PRACH association periods.
Clause 14. The method of any one of Clauses 9-13, wherein the plurality of PRACH occasions are associated with a same SSB or CSI-RS.
Clause 15. The method of any one of Clauses 9-14, wherein the random access message indicates a connection request, a scheduling request, or a buffer status request.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication performed by a user equipment (UE), comprising:
transmitting, to a network node, a plurality of physical random access channel (PRACH) preambles, each PRACH preamble being transmitted during a respective PRACH occasion of a plurality of PRACH occasions;
receiving, from the network node via a downlink control channel, a downlink grant indicating downlink resources for receiving a random access response (RAR) based on transmitting the plurality of PRACH preambles, the downlink control channel being scrambled based on a random access-radio network temporary identifier (RA-RNTI) associated with a single PRACH occasion of the plurality of PRACH occasions;
receiving, from the network node via the downlink resources, the RAR based on receiving the downlink grant; and
transmitting, to the network node, a random access message based on receiving the RAR.

2. The method of claim 1, wherein the single PRACH occasion is associated with an initial PRACH preamble transmission of the plurality of PRACH preamble transmissions.

3. The method of claim 1, wherein the single PRACH occasion is associated with a final PRACH preamble transmission of the plurality of PRACH preamble transmissions.

4. The method of claim 1, wherein each PRACH occasion is associated with a respective index of a plurality of indices, and
the method further comprises receiving a message indicating an index associated with the single PRACH occasion.

5. The method of claim 1, further comprising configuring an RAR window based on the single PRACH occasion.

6. The method of claim 1, wherein the plurality of PRACH preambles are transmitted over two or more PRACH association periods.

7. The method of claim 1, wherein the plurality of PRACH occasions are associated with a same synchronization signal block (SSB) or a same channel state information-reference signal (CSI-RS).

8. The method of claim 1, wherein the random access message indicates a connection request, a scheduling request, or a buffer status request.

9. An apparatus for wireless communications at a user equipment (UE), comprising:
a processor; and
a memory coupled with the processor and storing instructions operable, when executed by the processor, to cause the apparatus to:
transmit, to a network node, a plurality of physical random access channel (PRACH) preambles, each PRACH preamble being transmitted during a respective PRACH occasion of a plurality of PRACH occasions;
receive, from the network node via a downlink control channel, a downlink grant indicating downlink resources for receiving a random access response (RAR) based on transmitting the plurality of PRACH preambles, the downlink control channel being scrambled based on a random access-radio network temporary identifier (RA-RNTI) associated with a single PRACH occasion of the plurality of PRACH occasions;
receive, from the network node via the downlink resources, the RAR based on receiving the downlink grant; and
transmit, to the network node, a random access message based on receiving the RAR.

10. The apparatus of claim 9, wherein the single PRACH occasion is associated with an initial PRACH preamble transmission of the plurality of PRACH preamble transmissions.

11. The apparatus of claim 9, wherein the single PRACH occasion is associated with a final PRACH preamble transmission of the plurality of PRACH preamble transmissions.

12. The apparatus of claim 9, wherein:
each PRACH occasion is associated with a respective index of a plurality of indices, and
execution of the instructions further cause the apparatus to receive a message indicating an index associated with the single PRACH occasion.

13. The apparatus of claim 9, wherein execution of the instructions further cause the apparatus to configure an RAR window based on the single PRACH occasion.

14. The apparatus of claim 9, wherein the plurality of PRACH preambles are transmitted over two or more PRACH association periods.

15. The apparatus of claim 9, wherein the plurality of PRACH occasions are associated with a same synchronization signal block (SSB) or a same channel state information-reference signal (CSI-RS).

16. The apparatus of claim 9, wherein the random access message indicates a connection request, a scheduling request, or a buffer status request.

17. A method for wireless communication performed by a network node, comprising:
receiving a plurality of physical random access channel (PRACH) preambles, each PRACH preamble associated with a respective PRACH occasion of a plurality of PRACH occasions configured at a user equipment (UE);
transmitting, via a downlink control channel, a downlink grant indicating downlink resources for receiving a random access response (RAR) based on receiving the plurality of PRACH preambles, the downlink control channel being scrambled based on a random access-radio network temporary identifier (RA-RNTI) associated with a single PRACH occasion of the plurality of PRACH occasions;
transmitting, via the downlink resources, the RAR based on transmitting the downlink grant; and
receiving a random access message based on transmitting the RAR.

18. The method of claim 17, wherein the single PRACH occasion is associated with an initial PRACH preamble of the plurality of PRACH preambles.

19. The method of claim 17, wherein the single PRACH occasion is associated with a final PRACH preamble of the plurality of PRACH preambles.

20. The method of claim 17, wherein each PRACH occasion is associated with a respective index of a plurality of indices, and
the method further comprises transmitting a message indicating an index associated with the single PRACH occasion.

21. The method of claim 17, wherein the plurality of PRACH preambles are received over two or more PRACH association periods.

22. The method of claim 17, wherein the plurality of PRACH occasions are associated with a same synchronization signal block (SSB) or channel state information-reference signal (CSI-RS).

23. The method of claim 17, wherein the random access message indicates a connection request, a scheduling request, or a buffer status request.

24. An apparatus for wireless communications at a network node, comprising:
a processor; and
a memory coupled with the processor and storing instructions operable, when executed by the processor, to cause the apparatus to:
receive a plurality of physical random access channel (PRACH) preambles, each PRACH preamble associated with a respective PRACH occasion of a plurality of PRACH occasions configured at a user equipment (UE);
transmit, via a downlink control channel, a downlink grant indicating downlink resources for receiving a random access response (RAR) based on receiving the plurality of PRACH preambles, the downlink control channel being scrambled based on a random access-radio network temporary identifier (RA-RNTI) associated with a single PRACH occasion of the plurality of PRACH occasions;
transmit, via the downlink resources, the RAR based on transmitting the downlink grant; and
receive a random access message based on transmitting the RAR.

25. The apparatus of claim 24, wherein the single PRACH occasion is associated with an initial PRACH preamble of the plurality of PRACH preambles.

26. The apparatus of claim 24, wherein the single PRACH occasion is associated with a final PRACH preamble of the plurality of PRACH preambles.

27. The apparatus of claim 24, wherein:
each PRACH occasion is associated with a respective index of a plurality of indices, and
execution of the instructions further cause the apparatus to transmit a message indicating an index associated with the single PRACH occasion.

28. The apparatus of claim 24, wherein the plurality of PRACH preambles are received over two or more PRACH association periods.

29. The apparatus of claim 24, wherein the plurality of PRACH occasions are associated with a same synchronization signal block (SSB) or channel state information-reference signal (CSI-RS).

30. The apparatus of claim 24, wherein the random access message indicates a connection request, a scheduling request, or a buffer status request.
